(19) United States
(12) Patent Application Publication
(10) Pub. No.: US 2025/0315726 A1
(43) Pub. Date: Oct. 9, 2025

(54) HUMAN FLOW PREDICTION DEVICE, HUMAN FLOW PREDICTION PROGRAM, AND HUMAN FLOW PREDICTION METHOD

(71) Applicant: HITACHI, LTD., Tokyo (JP)

(72) Inventors: Kenta ISHII, Tokyo (JP); Erika TANAKA, Tokyo (JP); Daisuke MATSUBARA, Tokyo (JP)

(21) Appl. No.: 18/865,437

(22) PCT Filed: Feb. 27, 2023
(86) PCT No.: PCT/JP2023/007150

§ 371 Date: Nov. 13, 2024

(30) Foreign Application Priority Data
May 23, 2022 (JP) 2022-083696

(51) Int. Cl. G06N 20/00

(52) U.S. Cl. CPC G06N 20/00

(57) ABSTRACT

An effect of a measure implemented only in a limited period of time on a human flow is appropriately evaluated. A server computer is configured to acquire a generated traffic amount in a prediction target area and includes a measure registration unit configured to reflect an evaluation target measure to a feature of an implementation point in the prediction target area in an implementation period of time. A human flow prediction unit is configured to input a feature in the prediction target area in each period of time set by the measure registration unit and the generated traffic amount in a prediction target period of time to a time-series consideration route selection model trained by associating human flow information including movement and congestion in each period of time with a feature at each point in the prediction target area, and to predict a movement route of each prediction target.

### TECHNICAL FIELD

The present invention relates to a human flow prediction device, a human flow prediction program, and a human flow prediction method.

### BACKGROUND ART

In recent years, temporary use of urban spaces has become active. With an ongoing population decline, it is conceivable that it is more important to implement measures to limit periods of time in response to demand, such as opening of kitchen cars or parklets that temporarily occupy road spaces to make areas for people. To implement measures to limit periods of time in response to demand, it is necessary to verify effects of implementing measures in advance.

PTL 1 discloses a scheme of using a training model as a human flow prediction system, and performing zoning of a field in a grid-like pattern or the like on human flow data observed on a certain field and then using inflow and outflow information of people between zones to predict a human flow at a current time based on data at a time before a prediction time on the same field.

On the other hand, PTL 2 discloses a scheme of quantifying features of a surrounding environment of a prediction target and using a model that learned a relationship between the features and movement and congestion behaviors of the prediction target so that a human flow distribution can be predicted without depending on a specific condition such as ascertainment of a traffic amount at a time before a prediction target time that is a prerequisite in a scheme of the related art.

### CITATION LIST

### Patent Literature

PTL 1: JP2020-9124A
PTL 2: JP2020-194255A

### SUMMARY OF INVENTION

### Technical Problem

In the invention disclosed in PTL 1, a tendency change in a human flow according to a period of time can be predicted, but a traffic amount in a previous period of time is necessary as input information and an influence of a measure on a human flow cannot be taken into account. On the other hand, in the invention disclosed in PTL 2, a traffic amount in a previous period of time is not necessary as input information in human flow prediction. However, an influence of a measure implemented only in a certain period of time on a human flow cannot be evaluated, and an influence of the measure on behaviors of people not located near an implementation place cannot be taken into account either.

Accordingly, an object of the present invention is to appropriately evaluate an effect of a measure implemented only in a limited period of time on a human flow without using a traffic amount in a previous period of time as input information.

### Solution to Problem

To solve the above problem, according to an aspect of the present invention, a human flow prediction device includes: a generated traffic amount extraction unit configured to acquire a generated traffic amount in a prediction target area; a measure registration unit configured to reflect an evaluation target measure to a feature of an implementation point in the prediction target area in an implementation period of time; and a human flow prediction unit configured to input a feature in the prediction target area in each period of time set by the measure registration unit and the generated traffic amount in a prediction target period of time acquired by the generated traffic extraction unit to a model trained by associating human flow information including movement and congestion in each period of time with a feature at each point in the prediction target area, and to predict a movement route of each prediction target or a traffic amount of each point of the prediction target area.

According to another aspect of the present invention, a human flow prediction program causes a computer to perform: a procedure of extracting a generated traffic amount in a prediction target area; a procedure of reflecting an evaluation target measure to a feature of an implementation point in the prediction target area in an implementation period of time; and a procedure of predicting a movement route of each prediction target or a traffic amount of each point of the prediction target area based on a model trained by associating human flow information including movement and congestion in each period of time with a feature at each point in the prediction target area, a feature in the prediction target area in each period of time, and a generated traffic amount in the extracted prediction target period of time.

According to still another aspect of the present invention, a human flow prediction method includes: a step of receiving measure information by an input device; a step of accepting the measure information and a generated traffic amount in a prediction target area as an input and predicting a movement route of each prediction target and a traffic amount of each point using a route selection model; and a step of displaying a prediction result screen in which a prediction target period of time is displayed in an explicit format in a display mode according to the movement route or the traffic amount predicted in the prediction target area on a map indicating the prediction target area so that the predicted movement route or traffic amount is displayed.

The other means will be described in descriptions of embodiments.

### Advantageous Effects of Invention

According to the present invention, it is possible to evaluate an effect of a measure implemented only in a limited period of time on a human flow without using a traffic amount in a previous period of time as input information.

### BRIEF DESCRIPTION OF DRAWINGS

FIG. 1 is a block diagram illustrating an entire configuration of a human flow prediction system according to an embodiment.

FIG. 2 is a block diagram illustrating a hardware configuration of the human flow prediction system.

FIG. 3 is a diagram illustrating a configuration and a data example of a network database.

FIG. 4 is a diagram illustrating a configuration and a data example of a human flow database.

FIG. 5 is a flowchart illustrating a model learning process performed by the human flow prediction system.

FIG. 6 is a diagram illustrating an example of a recurrent neural network.

FIG. 7 is a flowchart illustrating a human flow prediction process performed by the human flow prediction system.

FIG. 8 is a diagram illustrating a measure registration screen output by the human flow prediction system.

FIG. 9 is an exemplary diagram illustrating a prediction result screen output by the human flow prediction system.

FIG. 10 is another exemplary diagram illustrating the prediction result screen output by the human flow prediction system.

### DESCRIPTION OF EMBODIMENTS

Hereinafter, modes for carrying out the present invention will be described with reference to the drawings and mathematical formulae.

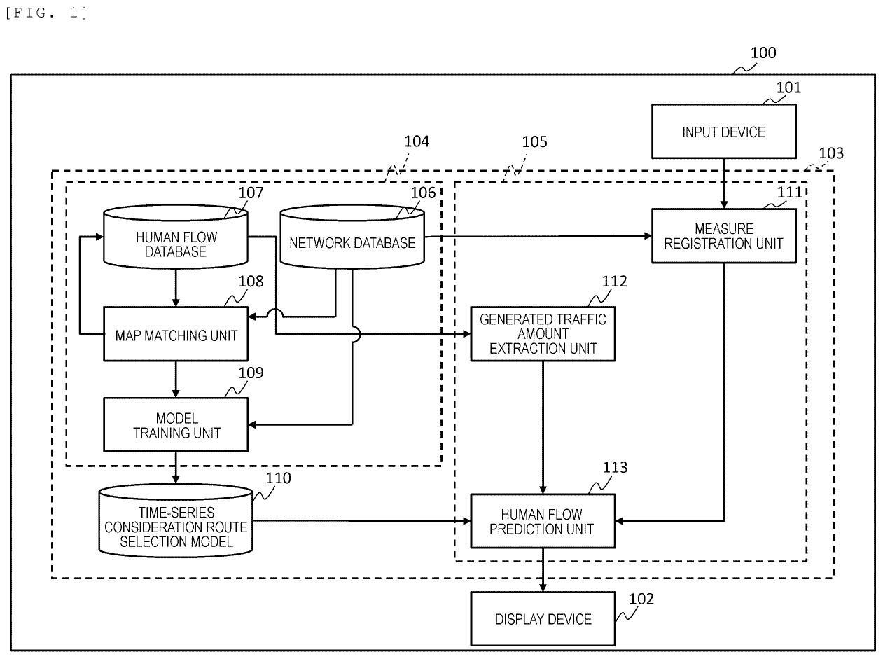

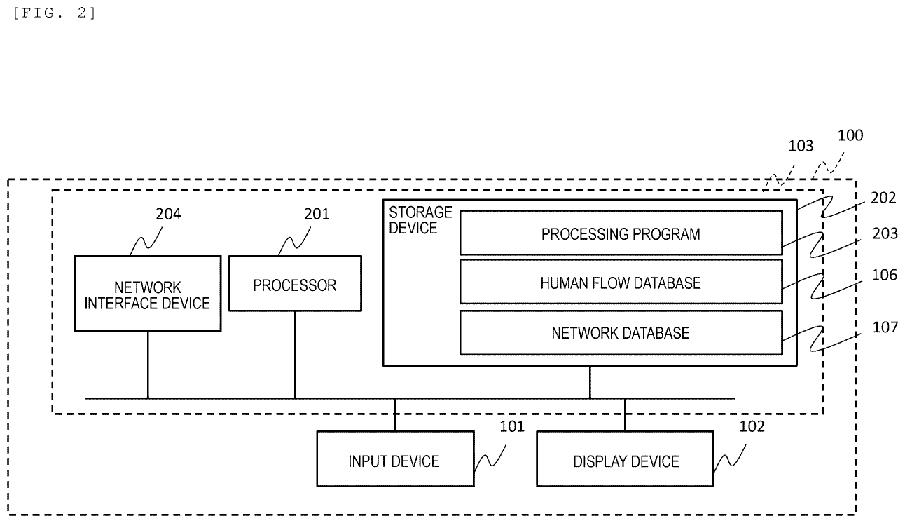

FIG. 1 is a block diagram illustrating an entire configuration of a human flow prediction system 100 according to an embodiment. An actual hardware configuration will be described below with reference to FIG. 2.

The human flow prediction system 100 according to the embodiment is an information processing system that includes an input device 101, a display device 102, and a server computer 103.

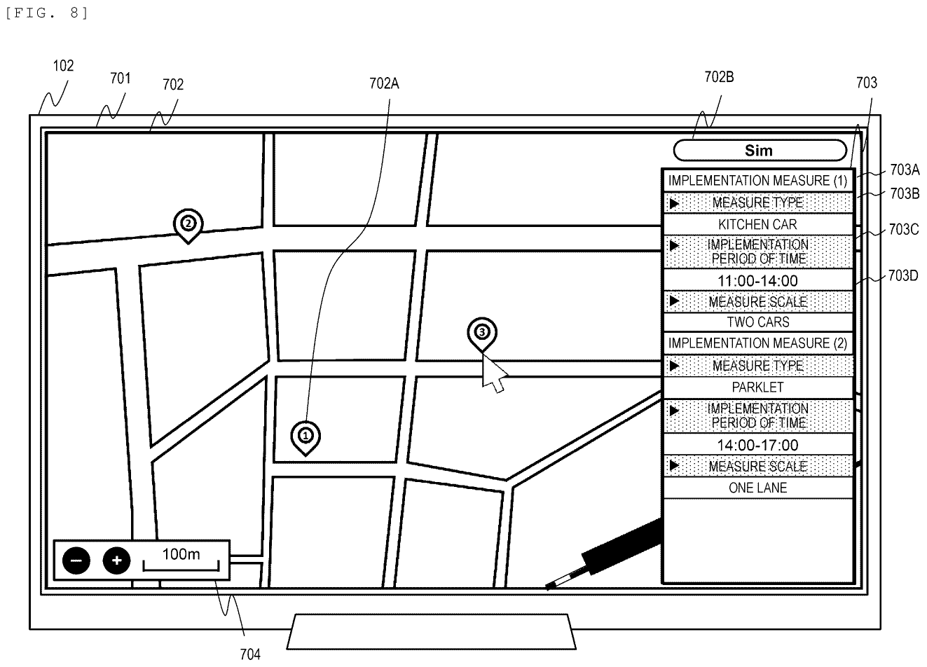

The input device 101 is an input interface such as a mouse, a keyboard, or a touch device that transfers an operation of a user to the server computer 103. The display device 102 is an output interface such as a liquid crystal display and is used to display a prediction result of the server computer 103 and perform an interactive operation with the user. The input device 101 and the display device 102 may be configured as an integrated touch panel display. The display device 102 displays a measure registration screen 701 illustrated in FIG. 8 to be described below. An operation on a button in the measure registration screen 701 is performed by the user operating the input device 101.

The server computer 103 is a computer that functions as a human flow prediction device and includes a training unit 104, a prediction unit 105, and a time-series consideration route selection model 110 generated by the training unit 104 as a functional configuration.

The training unit 104 includes a network database 106, a human flow database 107, a map matching unit 108, and a model training unit 109. The prediction unit 105 includes a measure registration unit 111, a generated traffic amount extraction unit 112, and a human flow prediction unit 113. The time-series consideration route selection model 110 is stored in a predetermined storage area of the server computer 103.

Hereinafter, each functional configuration of the training unit 104 will be described.

The human flow database 107 stores trajectory data that is time-series data of positional coordinates of each observation target. The network database 106 stores network data of a prediction target area.

The map matching unit 108 accepts trajectory data of the human flow database 107 and network data of a prediction target area of the network database 106 as an input and converts the trajectory data that is time-series data of positional coordinates into time-series data of passage links on a network (hereinafter referred to as a link transition series).

The trajectory data is time-series data of observation information including positional coordinates and a speed of a person in each observation time. Here, the trajectory data is assumed to be data obtained by observing a position of a communication device such as a cellphone carried by each observation target by global positioning system (GPS), Wi-Fi (registered trademark) positioning, or the like. The network data is a graph in which intersections in the prediction target area as nodes and roads as links are stretched and includes coordinate information of a node in each period of time, a feature unique to a node (hereinafter referred to as a node feature), link data connecting nodes to each other, and a feature unique to a link (hereinafter referred to as a link feature). Hereinafter, each point indicates each node or each link on the network.

The prediction target area is an area where a user desires to make prediction. The prediction target area is an area where a node or a link can be acquired and an area where there is trajectory data that is available for training and there are a node feature and a link feature (hereinafter referred to as network features) that can be acquired.

Here, the node feature indicates environment information associated with a node, such as whether there is a signal at an intersection corresponding to a node or the number of connected roads. The link feature indicates environment information associated with a link, such as a width, a road length, and the number of stores or the number of parks adjacent to the road of a road corresponding to a link. A data structure or the like of the node feature and the link feature will be described below.

The map matching unit 108 converts trajectory data that is coordinate information into a transition series of passage links or passage nodes on a network to correspond to the trajectory data and the network data in the prediction target area. Here, the map matching unit 108 allocates an identifiable ID (hereinafter referred to as a trip ID) to manage information in which a transition series and each passage time of series of passage links or passage nodes of each individual are put together (hereinafter referred to as trip information).

The process can be implemented using any method such as a known method. For example, the following example can be exemplified as a map matching scheme for trajectory data including an observation error.

When the trajectory data includes an observation error, the human flow prediction system 100 cannot determine the number of passage links as one. When coordinates of a trajectory are missed in observation, the human flow prediction system 100 may not be able to determine the passage links. On the other hand, the human flow prediction system 100 handles passage links according to an algorithm that has rule bases indicating whether a passage link of each individual is connected to a subsequent passage link or a link that has a small total sum of distances between coordinates in connection trajectory data and candidate links is connected to a passage link.

The map matching unit 108 delivers the transition series and each passage time of series of generated passage links or passage nodes of each individual to the model training unit 109 and delivers trip data management information 420 in each piece of trip information to the human flow database 107.

The model training unit 109 generates the time-series consideration route selection model 110 by training parameters of the time-series consideration route selection model 110 in association with tip information that has a period of time delivered from the map matching unit 108 as a departure time and a network feature at each period of time delivered from the network database 106. The trip information is human flow information including movement and congestion at each period of time. A network feature at each period of time delivered from the network database 106 is a feature of each point in the prediction target area.

The model training unit 109 uses a feature of a node handling the environment information associated with the node and a feature of a link handling environment information associated with the link as features of each point for training the model. A feature of a node is environment information associated with the node, the environment information including whether there is a signal of an intersection corresponding to the node and the number of connected roads. The feature of a link is environment information associated with the link, the environment information including one of a width, a road length, the number of stores adjacent to the road, and the number of parks adjacent to the road of a road corresponding to the link.

The model training unit 109 is an optional component. The human flow prediction system 100 may not include the model training unit 109 and a trained time-series consideration route selection model 110 may be provided instead, and the present invention is not limited thereto.

The time-series consideration route selection model 110 according to the embodiment has a graph convolution layer for extracting an intermediate feature. In the time-series consideration route selection model 110, a feature of each point in each period of time is input to the graph convolution layer to calculate the intermediate feature related to a relationship with the circumference on a network graph from the features of each point for each period of time.

Subsequently, the model training unit 109 inputs an output of the graph convolution layer in each period of time to a recurrent neural network of a corresponding time step. Accordingly, the intermediate feature in each period of time and human flow information including movement and congestion in each period of time is trained in association. In the embodiment, a case in which a model structure of a long-short term memory (LSTM) is used will be described.

In many schemes using a recurrent neural network such as the LSTM of the related art, a time step of a model corresponds to one step of time-series data. On the other hand, particularly in movement of people outdoor, the number of transitions of links or nodes tends to increase. The recurrent neural network has a problem that it is difficult to perform training as the number of transitions is larger. To solve the problem, in the embodiment, a relationship between the periods of time is trained assuming that behavioral preference of people in the same period of time is constant.

The model training unit 109 trains parameters of the graph convolution layer and the LSTM so that the transition probability distribution and a transition probability distribution obtained from an observed link transition series become close to each other.

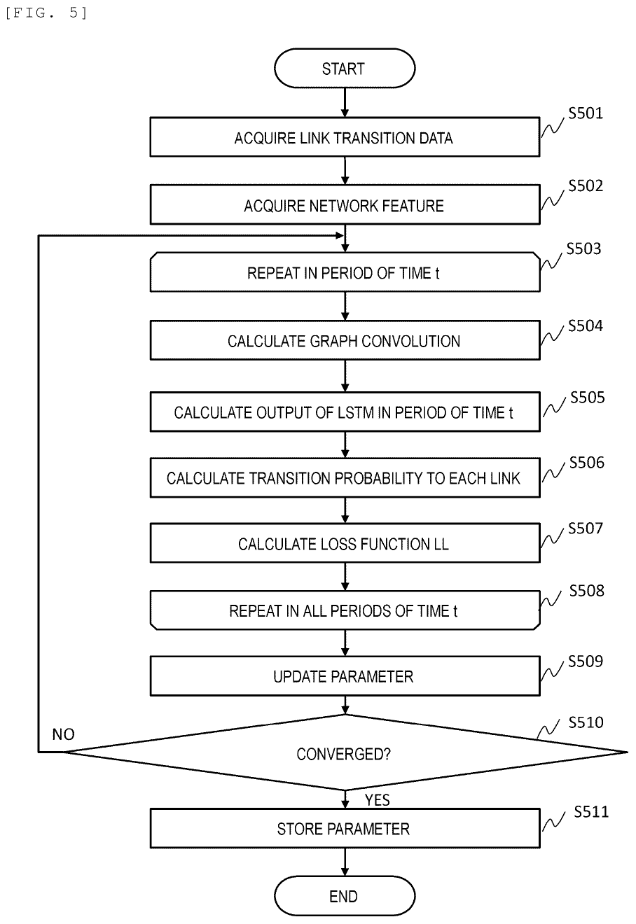

Specifically, by using all the link transition series within a trip of which a departure time is in the same period of time as training data of the recurrent neural network of the same time step and associating the link transition series with an output of a graph pooling layer in each period of time, parameters of each layer and parameters of the recurrent neural network are trained simultaneously. A specific calculation flow will be described in detail in description of FIG. 5.

Next, each functional configuration of the prediction unit 105 will be described.

The measure registration unit 111 acquires evaluation target measure information from the input device 101 and reflects an evaluation target measure to a feature of an implementation point in a prediction target area in an implementation period of time. Here, the measure information includes one of a type of measure, a measure implementation period of time, a measure implementation location, and a measure implementation scale. The type of evaluation target measure is limited to an item included in the feature of each point trained in advance.

The measure registration unit 111 acquires network data from the network database 106, reflects the measure information acquired from the input device 101 to the network data, and delivers the network data to the human flow prediction unit 113.

The generated traffic amount extraction unit 112 acquires trip information from the human flow database 107, counts the number of trips in which each point in each period of time is a start point, and delivers the trip information to the human flow prediction unit 113. Here, the trip information is a generated traffic amount in a prediction target period of time acquired by the generated traffic amount extraction unit 112.

Here, when the generated traffic amount of each point is all ascertained, the human flow prediction unit 113 can predict a passage traffic amount of each link or each node in each period of time. When a sampled generated traffic amount is counted as in the trip information and the like processed by the map matching unit 108, a passage traffic distribution of each link or each node in each period of time can be predicted. When the generated traffic amount in each period of time can be ascertained at only a certain single point, a usage method of predicting a passage traffic amount of each link or each node of people in which the single point is a departure point can also be used. A specific prediction method will be described in description of the human flow prediction unit 113 and description of FIG. 5.

The human flow prediction unit 113 inputs the network data delivered from the measure registration unit 111 and generated traffic amount information in each prediction target period of time delivered from the generated traffic amount extraction unit 112 to the time-series consideration route selection model 110, and predicts human flow information in each period of time. The network data delivered from the measure registration unit 111 is a feature in a prediction target area in each period of time.

The human flow prediction unit 113 constructs, as a feature, a network graph in which intersections in the prediction target area are nodes and roads are links, and handles each node or each link as each point. The feature of the node is environment information associated with the node, the environment information including whether there is a signal of an intersection corresponding to a node or the number of roads connected to the node. The feature of the link is environment information associated with the link, the environment information including one of a width, a length of the road, the number of stores adjacent to the road, and the number of parks adjacent to the road of a road corresponding to the link.

First, the human flow prediction unit 113 inputs the parameters of the time-series consideration route selection model 110 trained by the model training unit 109 and the generated traffic amount information in each prediction target period of time to the time-series consideration route selection model 110, and predicts each link transition probability. Each link transition probability is a prediction of a movement route of each agent (prediction target) or a traffic amount of each point of the prediction target area.

The human flow prediction unit 113 can calculate a passage traffic amount or a passage traffic amount distribution of each link or each node in each period of time from a link transition probability in each period of time and the generated traffic amount or the generated traffic amount distribution of each point. The calculation can be implemented using any method such as a known method.

Subsequently, the human flow prediction unit 113 predicts a route selected by each prediction target from a selection probability of a movement route at each departure point in each period of time. The human flow prediction unit 113 randomly generates routes by a number proportional to each generated traffic amount according to a probability from the selection probability of the movement route at each departure point in each period of time. Here, the human flow prediction unit 113 may adjust patterns of the generated routes according to a calculation amount. Then, the human flow prediction unit 113 sets a total number of agents (prediction targets) selecting the routes of each pattern to a multiple of a constant so that the total number of agents matches each generated traffic amount.

Subsequently, the human flow prediction unit 113 calculates coordinates of a passage position on the route and passage time information (hereinafter referred to as movement point information) at a predetermined time interval assuming that the agent (prediction target) moves at a constant speed on the generated route. The human flow prediction unit 113 can change whether to perform the prediction process for the movement route by setting in advance and may not necessarily predict the route.

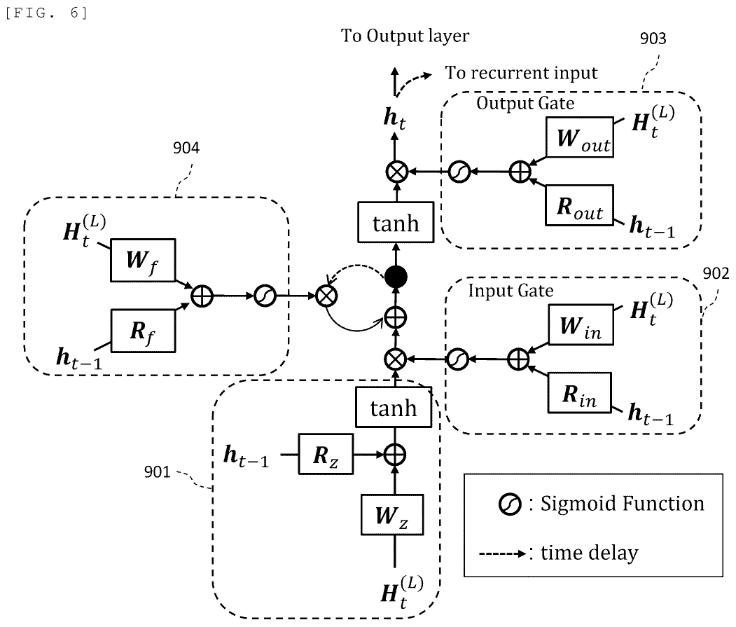

A specific calculation flow will be described in detail in description of FIG. 6.

The human flow prediction unit 113 outputs a predicted passage traffic amount, passage traffic amount distribution, or movement point information of each link and each node in each time period of time to the display device 102.

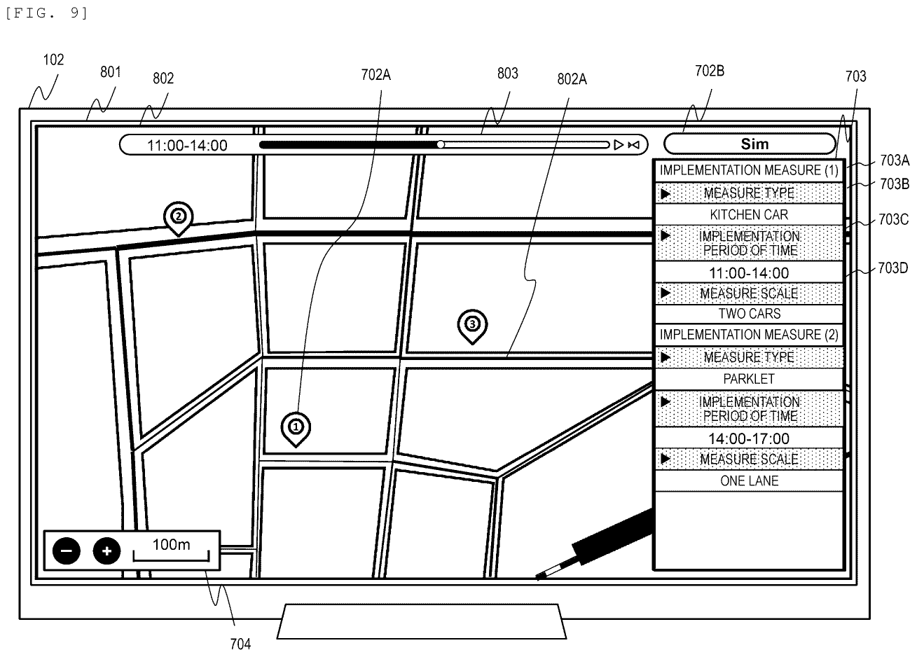

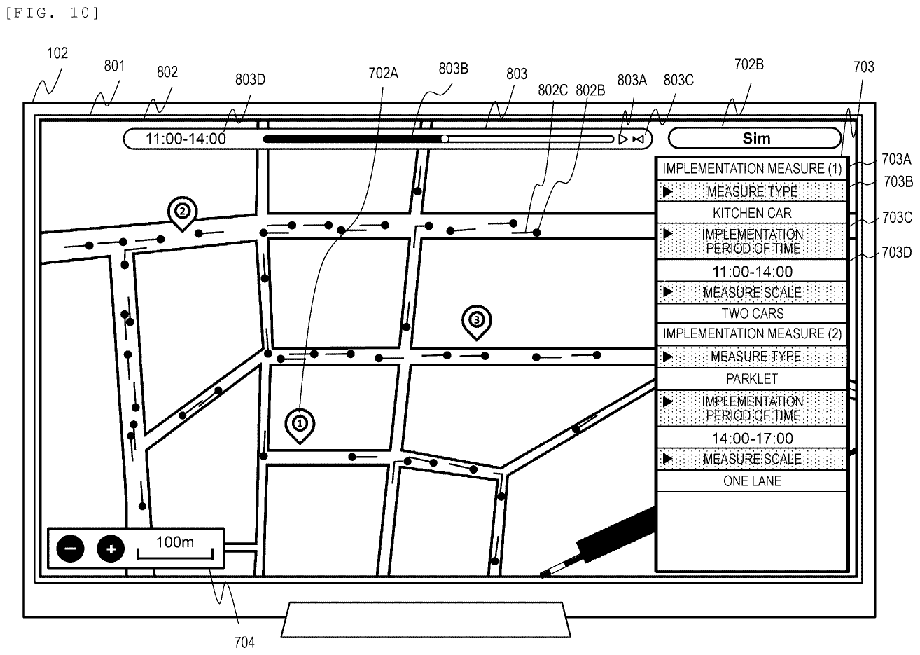

Specifically, when a link traffic amount is displayed, for example, a method of expressing magnitude of a traffic amount with a thickness, a depth of color, or the like of the link is conceivable. When a route is displayed, for example, a method of expressing points moving at a constant speed on a selected route by animation is conceivable. The details of a screen configuration will be described with reference to FIGS. 9 and 10.

FIG. 2 is a block diagram illustrating a hardware configuration of the human flow prediction system 100.

The server computer 103 is a general computer that includes a processor 201 and a storage device 202 connected to each other. The storage device 202 is configured with any type of storage medium. For example, the storage device 202 may include a semiconductor memory and a hard disk drive.

In the example, functional units such as the map matching unit 108, the model training unit 109, the measure registration unit 111, the generated traffic amount extraction unit 112, and the human flow prediction unit 113 illustrated in FIG. 1 are implemented by the processor 201 executing a processing program 203 stored in the storage device 202.

In other words, in the embodiment, a process performed by each of the above functional units is actually implemented by the processor 201 that follows a command described in the processing program 203. The network database 106 and the human flow database 107 are included in the storage device 202. Display by the display device 102 is implemented by the processor 201 generating data for display and outputting the data to the display device 102 and the display device 102 performing display according to the data.

The server computer 103 further includes a network interface device 204 connected to the processor 201.

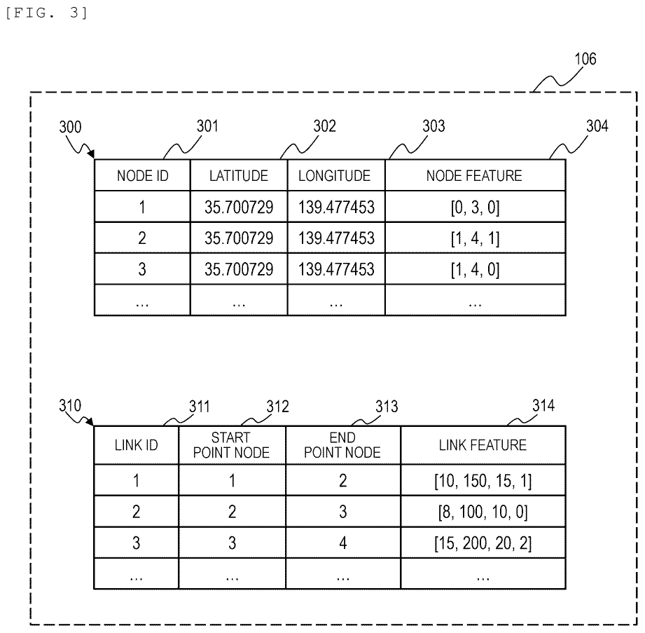

FIG. 3 is a diagram illustrating a configuration and a data example of the network database 106. Here, a configuration example in a table format will be described, but a data format is not limited to the table format and any format may be used.

The network database 106 includes node information 300 and link information 310 illustrated in FIG. 3. A table configuration and a field configuration of each table in FIG. 3 are configurations necessary to embody the present invention. Tables and fields may be added according to an application.

The node information 300 includes a node ID field 301, a latitude field 302, a longitude field 303, and a node feature field 304.

The node ID field 301 stores identification information of each node (hereinafter referred to as a node ID).

The latitude field 302 stores latitude information of positional coordinates of each node.

The longitude field 303 stores longitude information of positional coordinates of each node.

The node feature field 304 stores a feature associated with each node (hereinafter referred to as a node feature). When a node feature is different for each period of time, the node feature field 304 may be added for each period of time.

Here, examples of the node feature include whether there is a signal of an intersection corresponding to each node, the number of connected roads, and whether there is a crossing. The first row [0, 3, 0] of the node feature field 304 indicates that there is no signal in a node that has a node ID of 1, there is a three-way junction that has three connected roads, and there is no crossing.

The link information 310 includes a link ID field 311, a start point node field 312, an end point node field 313, and a link feature field 314.

The link ID field 311 stores identification information of each link (hereinafter referred to as a link ID). The start point node field 312 stores a node ID of a start point node of each link. The end point node field 313 stores a node ID of an end point node of each link.

The link feature field 314 stores a feature associated with each link (hereinafter referred to as a link feature). When the link feature is different for each period of time, the link feature field 314 may be added for each period of time.

Here, examples of the link feature include a width, a road length, the number of stores, or the number of parks adjacent to the road of a road corresponding to each link. The first row [10, 150, 15, 1] of the link feature field 314 indicates that a width of a link with a link ID of 1 is 10 m, a road length is 150 m, the number of adjacent stores is 15, and the number of adjacent parks is 1.

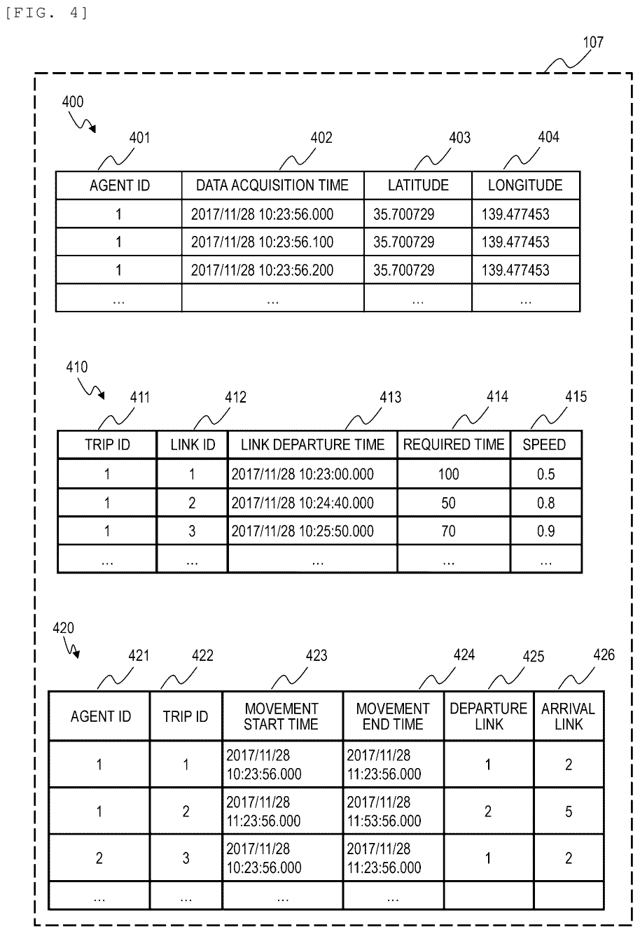

FIG. 4 is a diagram illustrating a configuration and a data example of the human flow database 107. Here, a configuration example in a table format will be described, but a data format is not limited to the table format and any format may be used.

The human flow database 107 includes trajectory data management information 400, link transition data management information 410, and trip data management information 420 illustrated in FIG. 4. A table configuration and a field configuration of each table in FIG. 4 are configurations necessary to embody the present invention. Tables and fields may be added according to an application.

The trajectory data management information 400 includes an agent ID field 401, a data acquisition time field 402, a latitude field 403, and a longitude field 404.

The agent ID field 401 stores identification information of a target from which each piece of trajectory data is acquired (hereinafter referred to as an agent ID).

The data acquisition time field 402 stores information regarding a time at which a trajectory point is acquired.

The latitude field 403 stores latitude information of a position at which the trajectory point is acquired.

The longitude field 404 stores longitude information of the position at which the trajectory point is acquired.

The link transition data management information 410 includes a trip ID field 411, a link ID field 412, a link departure time field 413, a required time field 414, and a speed field 415.

The trip ID field 411 stores identification information of a trip to which each link transition series belongs (hereinafter referred to as a trip ID).

The link ID field 412 stores a link ID that is identification information of each link through which an agent passes.

The link departure time field 413 stores a time at which the agent departs from a start point of each passage link.

The required time field 414 stores a time required for the agent to pass through each link. Here, seconds may be adopted as a unit of the required time, but the unit of the required time may be changed according to observation target transportation means or the like.

The speed field 415 stores a speed at a time at which each agent passes through each link. Here, km/h is adopted as a unit of the speed in the speed field 415, but the unit of the speed may be changed according to observation target transportation means or the like.

The trip data management information 420 includes an agent ID field 421, a trip ID field 422, a movement start time field 423, a movement end time field 424, a departure link field 425, and an arrival link field 426.

The agent ID field 421 stores an agent ID of an agent performing trip of each trip ID.

The trip ID field 422 stores a trip ID of each trip.

The movement start time field 423 stores a time at which each trip is started.

The movement end time field 424 stores a time at which each trip is ended.

The departure link field 425 stores a link ID that is an identifier of a link that is a departure point of each trip.

The arrival link field 426 stores a link ID that is an identifier of a link that is an arrival point of each trip.

FIG. 5 is a flowchart illustrating a model learning process performed by the human flow prediction system 100.

In the embodiment of the present invention, a method of training and predicting a subsequent link transition series will be described. However, a node transition series can also be trained and predicted according to a similar method.

First, the model training unit 109 acquires link transition data from the map matching unit 108 (step S501). Subsequently, the model training unit 109 acquires node information and link information as network features from the network database 106 (step S502). Subsequently, the human flow prediction system 100 repeatedly performs steps S504 to S507 that are processes related to a predetermined period of time t (steps S503 and S508).

Here, as methods of determining a range of the period of time, a method of performing grid search by training of each model at a plurality of ranges of the period of time, comparing estimation accuracy after training between ranges of the period of time, and determining a range of the period of time with highest estimation accuracy, a method of determining a range of the period of time, for example, by manually interpreting a period of time such as a commute time, a lunch time, and a home return time from characteristics of an analysis target city, and the like are conceivable.

First, the human flow prediction system 100 performs a graph convolution process in a graph convolution layer. When L is the number of graph convolutions, l (where lϵA and 0≤l≤L)-th graph convolution process is calculated as follows (step S504).

$$\begin{matrix}[ Math . 1 ] & \\ {H}_{t}^{( l + 1 )} = f ( {H}_{t}^{( l )} , {A}_{t} ) & ( 1 )\end{matrix}$$

Here, the function f is defined as follows.

$$\begin{matrix}[ Math . 2 ] & \\ f ( {H}_{t}^{( l )} , {A}_{t} ) = σ ( {\hat{D}}^{- \frac{1}{2}} {\hat{A}}_{t} {\hat{D}}^{- \frac{1}{2}} {H}_{t}^{( l )} {W}^{( l )} ) & ( 2 )\end{matrix}$$

Here,
A\hat{ }ₜ: an adjacency matrix indicating a connection relation between links at the period of time t;
D\hat{ }: a degree matrix in which diagonal components are a degree of each link and others are 0;
σ: a nonlinear activation function such as a rectified linear unit (ReLU);
W⁽¹⁾: a first parameter that is a training target of a time-series consideration route selection model; and
When l=0, Hₜ⁽⁰⁾ is a feature matrix indicating a feature of each link in the same period of time t as Xₜ.

Next, an example of a network configuration of the LSTM according to the embodiment is illustrated in FIG. 6.

In FIG. 6, information flows from bottom to top. In a part labeled as a cell in the middle, there is a recurrent connection. A circled + represents a calculation that takes a sum of each component and a circled X represents a calculation that takes a multiplication of each component. A solid line represents an immediately operating flow. A dotted line represents a time delay and indicates an influence on a subsequent time.

The LSTM includes a memory element called a memory cell, a block input 901, an input gate 902, an output gate 903, and a forget gate 904.

In the input gate 902, Wᵢₙ that is a weight corresponding to an input and Rᵢₙ that is a weight corresponding to a recurrent input are respectively multiplied with corresponding inputs, results are added, and thus an added result is processed by a Sigmoid function.

In the output gate 903, Wₒᵤₜ that is a weight corresponding to an input and Rₒᵤₜ that is a weight corresponding to a recurrent input are respectively multiplied with corresponding inputs, results are added, and thus an added result is processed by a Sigmoid function.

In the forget gate 904, W_{f} that is an input and R_{f} that is a recurrent input are input to be added and an added result is processed by a Sigmoid function.

An input to a cell is an input of a normal neural network. An input is applied to the other three gates. The input to the three gates is used to open and close the gates.

The three gates are used to control how much information passes. When a gate is closed, the gate approaches 0. Therefore, it is difficult for information to pass. Conversely, when a gate is opened, the gate is in a positive state and the Sigmoid function is close to 1. When the forget gate 904 is opened, a state of a cell from one time earlier influences the current state of the cell. That is, a role of the forget gate 904 is to determine how much an influence of an immediately previous cell is considered. In a normal recurrent network, there are no gates. In the LSTM, gates have active roles and the gates themselves learn connection coefficients, so that a flow of information is controlled.

Description will be made referring back to FIG. 5. The human flow prediction system 100 calculates an output of the LSTM in the period of time t using the following formulae (3) to (8) (step S505).

$$\begin{matrix}[ Math . 3 ] & \\ {z}_{t} = tanh ( {W}_{z} {H}_{t}^{( L )} + {R}_{z} {Q}_{t - 1} ) & ( 3 )\end{matrix}$$

Here,
W_{z}: a weight corresponding to an input value of the block input of the LSTM;
R_{z}: a weight corresponding to a recurrent input value of the block input of the LSTM; and
zₜ: an output value of the block input of the LSTM in the period of time t.

$$\begin{matrix}[ Math . 4 ] & \\ {i}_{t} = {σ}_{s} ( {W}_{i n} {H}_{t}^{( L )} + {R}_{i n} {Q}_{t - 1} ) & ( 4 )\end{matrix}$$

Here,
Wᵢₙ: a weight corresponding to an input value of the input gate of the LSTM;
Rᵢₙ: a weight corresponding to a recurrent input value of the input gate of the LSTM;
iₜ: an output value of the input gate of the LSTM in the period of time t; and
σₛ: a Sigmoid function.

$$\begin{matrix}[ Math . 5 ] & \\ {f}_{t} = {σ}_{s} ( {W}_{f} {H}_{t}^{( L )} + {R}_{f} {Q}_{t - 1} ) & ( 5 )\end{matrix}$$

Here,
W_{f}: a weight corresponding to an input value of the forget gate of the LSTM;
R_{f}: a weight corresponding to a recurrent input value of the forget gate of the LSTM; and
fₜ: an output value of the forget gate of the LSTM in the period of time t.

$$\begin{matrix}[ Math . 6 ] & \\ {c}_{t} = {i}_{t} ⊙ {z}_{t} + {f}_{t} ⊙ {c}_{t - 1} & ( 6 )\end{matrix}$$

Here,
cₜ: a temporary value of the LSTM in the period of time t; and
cₜ₋₁: a temporary value of the LSTM in the period of time t−1.

$$\begin{matrix}[ Math . 7 ] & \\ {o}_{t} = {σ}_{s} ( {W}_{out} {H}_{t}^{( L )} + {R}_{out} {Q}_{t - 1} ) & ( 7 )\end{matrix}$$

Here,
Wₒᵤₜ: a weight corresponding to an input value of the output gate of the LSTM;
Rₒᵤₜ: a weight corresponding to a recurrent input value of the output gate of the LSTM; and
oₜ: an output value of the output gate of the LSTM.

$$\begin{matrix}[ Math . 8 ] & \\ {Q}_{t} = {o}_{r} ⊙ tanh ( {c}_{t} ) & ( 8 )\end{matrix}$$

Here,
W_{z}, Wᵢₙ, W_{f}, Wₒᵤₜ, R_{z}, Rᵢₙ, R_{f}, and Rₒᵤₜ: training target second parameters; and
Qₜ(k): an evaluation value of a link k that is a k-th element of an output in the period of time t of the LSTM.

As such, as an evaluation value of each link in each period of time, a value defined by a known model structure of a recurrent neural network, such as the LSTM that is the scheme described above, can be used.

Subsequently, a transition probability to each link is calculated. A transition probability from a link k to a link a (aϵA(k)) connected to the link k is calculated using a softmax function as in the following Formula (9) (step S506).

$$\begin{matrix}[ Math . 9 ] & \\ {P}_{t} ( a \vert k ) = \frac{exp {Q}_{t} ( a )}{{\sum }_{{a}^{'} ∈ A ( k )} exp ( {Q}_{t} ( {a}^{'} )} & ( 9 )\end{matrix}$$

Here,
A(k): a link set connected to the link k.

Then, a loss function LL is calculated as in the following Formula (10) using a calculated transition probability to each link and an observed link transition series (step S507).

$$\begin{matrix}[ Math . 10 ] & \\ {LL}_{t} = {LL}_{t - 1} + {\sum }_{{n}_{t}} \{ {Q}_{t} ( {a}^{( {n}_{t} )} ) - ln {\sum }_{{a}^{'} ∈ A ( {k}^{( {n}_{t} )} )} exp {Q}_{t} ( {a}^{'} ) \} & ( 10 )\end{matrix}$$

Here,
nₜ: an index of link transition belonging to a trip in which the period of time t is a link departure time;
k^{(nt)}: a link located before transition of link transition belonging to a trip in which the period of time t is a link departure time; and
a^{(nt)}: a link located after transition of the link transition.

When steps S504 to S507 that are processes related to all the periods of time ends, the model training unit 109 ends the calculation of the loss function and proceeds to step S509. Accordingly, the model training unit 109 updates the training targets second parameters W⁽¹⁾, W_{z}, Wᵢₙ, W_{f}, Wₒᵤₜ, R_{z}, Rᵢₙ, R_{f}, and Rₒᵤₜ (step S509).

In step S510, the model training unit 109 determines whether the training is converged. When the training is not converged (No), the model training unit 109 returns to step S503 and updates the parameters again. Conversely, when the training is converged (Yes), the model training unit 109 proceeds to step S511.

In step S511, the model training unit 109 ends the process of FIG. 6 when the training parameters of the model obtained through the above training are stored in the time-series consideration route selection model 110.

That is, the model training unit 109 trains a first parameter indicating an influence of the feature of each point in each period of time on a probability distribution indicating a probability of movement to a point adjacent or stay at the point from each point and a second parameter indicating an influence of a relationship between a feature of each point previous to a prediction target period of time and the probability in a period of time corresponding to the feature on the probability distribution in the prediction target period of time so that the probability distribution in the prediction target period of time predicted from a feature of each point matches the probability distribution in a target period of time obtained from information regarding an observed human flow that is training data for each period of time in a target area. The training data is data in which a plurality of pieces of trajectory data chronologically indicating observation information including positional coordinates and a speed at each observation time are converted into a transition series of nodes or links in association with a position on the network graph.

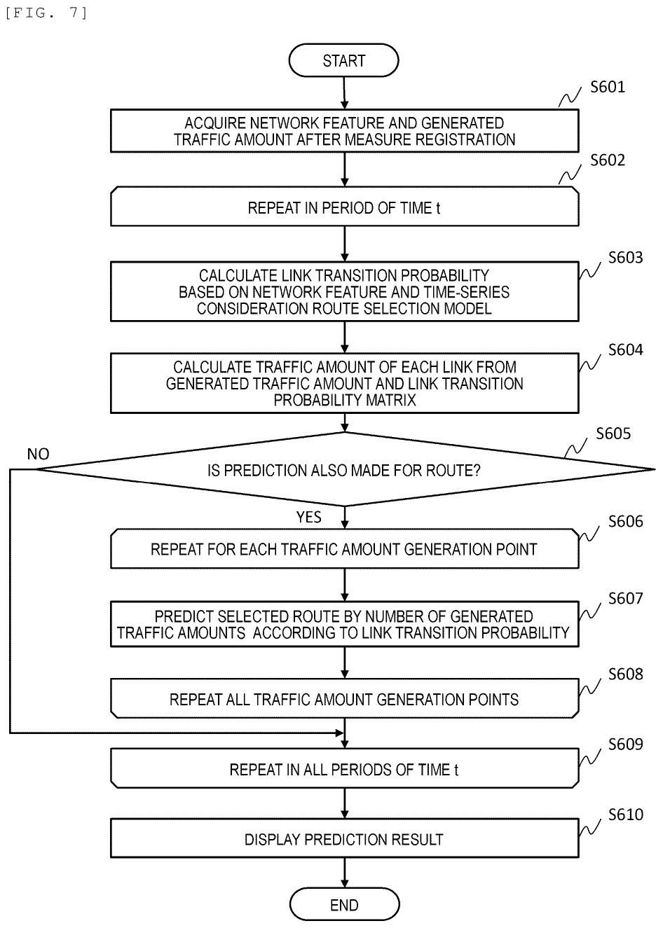

FIG. 7 is a flowchart illustrating a human flow prediction process performed by the human flow prediction system 100.

First, the human flow prediction unit 113 acquires node information and link information in which an examination measure is reflected as network features from the measure registration unit 111 and acquires a generated traffic amount of each point for each period of time from the generated traffic amount extraction unit 112 (step S601).

Subsequently, the human flow prediction system 100 performs steps S603 to S608 that are processes in the predetermined period of time (steps S602 and S609).

The human flow prediction unit 113 first calculates an evaluation value of each link as in the above-described Formula (8) using the network features and the time-series consideration route selection model 110. Accordingly, the human flow prediction unit 113 calculates a transition probability from a link k to a link a (aϵA(k)) connected to the link k as in the above-described Formula (9) (step S603).

Subsequently, the human flow prediction unit 113 calculates the traffic amount of each link from a link transition probability matrix storing the generated traffic amount and each link transition probability (step S604). The human flow prediction unit 113 can implement calculation of the link traffic amount using distribution of the traffic amount from the generated traffic amount and the link transition probability matrix, for example, by an absorption Markov process or any method such as another known method.

In step S605, the human flow prediction unit 113 determines whether prediction of the route is made and performs bifurcation. A determination flag is assumed to be designated in advance. When the prediction of the route is not made (No), the human flow prediction unit 113 proceeds to step S609. Conversely, when the prediction of the route is made (Yes), the human flow prediction unit 113 proceeds to step S606.

In steps S606 to S608, the human flow prediction unit 113 performs a process of step S607 for each traffic amount generation point.

In step S607, the human flow prediction unit 113 randomly generates the routes by the number of generated traffic amounts according to the link transition probability matrix. In step S608, the human flow prediction unit 113 proceeds to step S609 when all the traffic amount generation points are repeated. The human flow prediction unit 113 returns to step S606 when there is an unprocessed traffic amount generation point.

In step S609, the human flow prediction unit 113 proceeds to step S610 when the processes are repeated in all the periods of time. The human flow prediction unit 113 returns to step S602 when there is an unprocessed process in the period of time.

In step S610, the human flow prediction unit 113 ends the process of FIG. 7 when a prediction result is displayed. When the human flow prediction unit 113 displays a link traffic amount, for example, a method of expressing magnitude of traffic amount with a thickness, a depth of color, or the like of a link is conceivable. When a route is displayed, for example, a method of expressing points moving at a constant speed on a selected route by animation is conceivable. The details of a screen configuration will be described with reference to FIGS. 9 and 10.

FIG. 8 is a diagram illustrating a measure registration screen 701 output to the display device 102 by the human flow prediction system 100.

The human flow prediction unit 113 displays a measure registration screen 701 in which information regarding a measure can be input on a map indicating a prediction target area.

The measure registration screen 701 illustrated in FIG. 8 includes a map area 702, a measure registration area 703, and a scale management area 704.

In the map area 702, a map indicating a prediction target area is displayed, and a measure registration pin 702A and a simulation start button 702B are further displayed. In the map area 702, information regarding a measure can be input.

In the measure registration pin 702A, a number in which a measure registration order is an identification number (implementation measure ID) is displayed. The measure registration pin 702A is displayed when a user selects a point at which the measure is desired to be implemented.

In the measure registration area 703, the simulation start button 702B can be operated when setting of all registered measure content is completed. When the user operates the simulation start button 702B, the human flow prediction unit 113 performs a human flow prediction process and transitions to a prediction result screen 801 illustrated in FIGS. 9 and 10. When the user operates the map area itself, a scale or a display position can be changed. Here, a displaying angle of the map may be changeable. Accordingly, the measure can be examined according to a position of a characteristic location such as a main facility or a river, and thus it is easy to examine the measure.

In the measure registration area 703, an implementation measure ID 703A, a measure type selection button 703B, an implementation period-of-time selection button 703C, and a measure scale selection button 703D are displayed for each implementation measure ID according to a measure registered in the map area 702.

The user operates the measure type selection button 703B to select a measure type that is desired to be implemented at a position of the measure registration pin 702A corresponding to each implementation measure ID 703A. Here, selectable measure types are limited to types included in network features used for training by the training unit 104. Through the selection, an option of the measure scale selection button 703D is confirmed according to a measure, and the user operates the measure scale selection button 703D to select an implementation scale of the measure. The user operates the implementation period-of-time selection button 703C and selects a period of time for implementation in a period-of-time range set in advance by the training unit 104. Here, a plurality of periods of time can be selected.

The scale management area 704 manages a scale of a map displayed in the map area 702. A button with which the magnitude of the scale can be changed and a scale of a map that is being displayed in the map area 702 are displayed.

Here, there may be a display indicating a direction in the map that is being displayed in the map area 702. Accordingly, it is easy to examine a measure while considering a direction.

FIGS. 9 and 10 are other exemplary diagrams illustrating a prediction result screen 801 output to the display device 102 by the human flow prediction system 100.

The prediction result screen 801 illustrated in FIGS. 9 and 10 includes a prediction result display area 802, an animation control area 803, the measure registration area 703, and the scale management area 704.

In the prediction result display area 802 illustrated in FIG. 9, a traffic amount line 802A in which a thickness, a depth of color, or the like of a line is changed according to a traffic amount of each street of a prediction result is displayed in a format desired to be displayed. That is, the human flow prediction unit 113 displays the prediction result screen 801 in which each link of a prediction target area is displayed in a display mode according to a traffic amount of each point for each predicted period of time on a map indicating the prediction target area.

In the prediction result display area 802 illustrated in FIG. 10, a movement point 802B moving on a predicted route and a movement trajectory 802C several meters before are displayed. That is, the human flow prediction unit 113 displays the prediction result screen 801 in which a movement route of each prediction target for each predicted period of time of a prediction target area is displayed in a display mode according to the movement route on a map indicating the prediction target area. In the display mode according to the movement route, a movement route is displayed using a point indicating a position at each time of the movement route and a trajectory to the position.

In the animation control area 803, a play button 803A for playing and stopping an animation to control the traffic amount line 802A, the movement point 802B, and the movement trajectory 802C that change chronologically, a seek bar 803B for displaying and designating a timing to be displayed, a movement trajectory 803C in which the animation can be rewound, and a period-of-time designation button 803D capable of selecting a period of time to be displayed are displayed. The display mode according to the traffic amount is expressed with a change in a thickness or color of a line on a road of a prediction point.

Accordingly, even without a specific condition such as ascertainment of a traffic amount at a time previous to a prediction target time, a human flow change according to a measure implementation period of time or an influence on a human flow at a position away from an implementation location can be evaluated.

### MODIFICATIONS

The present invention is not limited to the above-described embodiments and includes various modifications. For example, the above-described embodiments have been described in detail to facilitate understanding of the present invention and the configurations described above may not be all included. Some of the configurations of a certain embodiment can be replaced with the configurations of another embodiment. Some of the configurations of a certain embodiment can be added to the configurations of another embodiment. Other configurations may be added to, deleted from, and replaced with some of the configurations of each embodiment.

Some or all of the above-described configurations, functions, processing units, processing methods, and the like may be implemented as hardware such as integrated circuits. The above-described configurations, functions, and the like may be implemented as software by causing a processor to analyze and execute a program that implements each function. Information such as a program, a table, or a file implementing each function can be stored in a storage device such as a memory, a hard disk, or a solid state drive (SSD) or a recording medium such as a flash memory card or a digital versatile disk (DVD).

In each embodiment, the control lines or information lines indicate lines considered to be necessary for description and are not all the control lines and information lines necessary for implementation. Actually, substantially all the configurations are assumed to be connected to each other.

### REFERENCE SIGNS LIST

100: human flow prediction system
101: input device
102: display device
103: server computer (human flow prediction device)
104: training unit
105: prediction unit
106: network database
107: human flow database
108: map matching unit
109: model training unit
110: time-series consideration route selection model (route selection model)
111: measure registration unit
112: generated traffic amount extraction unit
113: human flow prediction unit
201: processor
202: storage device
203: processing program
204: network interface device
300: node information
310: link information
301: node ID field
302: latitude field
303: longitude field
304: node feature field
311: link ID field
312: start point node field
313: end point node field
314: link feature field
400: trajectory data management information
401: agent ID field
402: data acquisition time field
403: latitude field
403: longitude field
410: link transition data management information
411: trip ID field
412: link ID field
413: link departure time field
414: required time field
415: speed field
420: trip data management information
421: agent ID field
422: trip ID field
423: movement start time field
424: movement end time field
425: departure link field
426: arrival link field
701: measure registration screen
702: map area
702A: measure registration pin
702B: simulation start button
703: measure registration area
703A: implementation measure ID
703B: measure type selection button
703C: implementation period-of-time selection button
703D: measure scale selection button
704: scale management area
801: prediction result screen
802: prediction result display area
802A: traffic amount line
802B: movement point
802C: movement trajectory
803: animation control area
803A: play button
803B: seek bar
803D: period-of-time designation button
901: block input
902: input gate
903: output gate
904: forget gate

1. A human flow prediction device comprising:
a generated traffic amount extraction unit configured to acquire a generated traffic amount in a prediction target area;
a measure registration unit configured to reflect an evaluation target measure to a feature of an implementation point in the prediction target area in an implementation period of time; and
a human flow prediction unit configured to input a feature in the prediction target area in each period of time set by the measure registration unit and the generated traffic amount in a prediction target period of time acquired by the generated traffic extraction unit to a model trained by associating human flow information including movement and congestion in each period of time with a feature at each point in the prediction target area, and to predict a movement route of each prediction target or a traffic amount of each point of the prediction target area.

2. The human flow prediction device according to claim 1, wherein
the human flow prediction unit constructs a network graph that has intersections in the prediction target area as nodes and roads as links as the feature and handles each of the nodes or each of the links as each point,
the feature of the node is environment information associated with the node, the environment information including whether there is a signal of an intersection corresponding to the node or the number of roads connected to the node, and
the feature of the link is environment information associated with the link, the environment information including one of a width, a length of the road, the number of stores adjacent to the road, and the number of parks adjacent to the road of a road corresponding to the link.

3. The human flow prediction device according to claim 1, wherein the model is a recurrent neural network in which a relationship between periods of time is trained.

4. The human flow prediction device according to claim 2, wherein the model is a model that calculates an intermediate feature related to a relationship on a network graph from the feature of each point for each period of time and is a model trained by associating the intermediate feature in each period of time with human flow information including movement and congestion in each period of time.

5. The human flow prediction device according to claim 4, wherein the model has a graph convolution layer for extracting the intermediate feature.

6. The human flow prediction device according to claim 1, further comprising a training unit configured to train the model.

7. The human flow prediction device according to claim 6, wherein the training unit constructs a network graph that has intersections in the prediction target area as nodes and roads as links and handles each of the nodes or each of the links as each point.

8. The human flow prediction device according to claim 7, wherein the training unit trains a first parameter indicating an influence of the feature of each point in each period of time on a probability distribution indicating a probability of movement to an adjacent point from each point or stay at the point and a second parameter indicating an influence of a relationship between a feature of each point previous to a prediction target period of time and the probability in a period of time corresponding to the feature on the probability distribution in the prediction target period of time so that the probability distribution in the prediction target period of time predicted from a feature of each point matches the probability distribution in a target period of time obtained from information regarding an observed human flow that is training data for each period of time in a target area.

9. The human flow prediction device according to claim 8, wherein the training data is data in which a plurality of pieces of trajectory data indicating a time series of observation information including positional coordinates and a speed at each observation time are converted into a transition series of the nodes or the links in association with a position on the network graph.

10. The human flow prediction device according to claim 1, wherein the human flow prediction unit displays a measure registration screen in which information regarding the measure is able to be input on a map indicating the prediction target area.

11. The human flow prediction device according to claim 1, wherein the human flow prediction unit displays a prediction result screen in which each link of the prediction target area is displayed on a map indicating the prediction target area in a display mode according to a traffic amount of each point for each predicted period of time.

12. The human flow prediction device according to claim 1, wherein the human flow prediction unit displays a prediction result screen in which a movement route of each prediction target for each predicted period of time of the prediction target area is displayed on a map indicating the prediction target area in a display mode according to the movement route.

13. A human flow prediction program causing a computer to perform:
a procedure of extracting a generated traffic amount in a prediction target area;
a procedure of reflecting an evaluation target measure to a feature of an implementation point in the prediction target area in an implementation period of time; and
a procedure of predicting a movement route of each prediction target or a traffic amount of each point of the prediction target area based on a model trained by associating human flow information including movement and congestion in each period of time with a feature at each point in the prediction target area and a generated traffic amount in the extracted prediction target period of time.

14. A human flow prediction method comprising:
a step of receiving measure information by an input device;
a step of accepting the measure information and a generated traffic amount in a prediction target area as an input and predicting a movement route of each prediction target or a traffic amount of each point using a route selection model; and
a step of displaying a prediction result screen in which a prediction target period of time is displayed in an explicit format in a display mode according to the movement route or the traffic amount predicted in the prediction target area on a map indicating the prediction target area so that the predicted movement route or traffic amount is displayed.

15. The human flow prediction method according to claim 14, wherein, in the display mode according to the movement route, the movement route is displayed using a point indicating a position at each time of the movement route and a trajectory to the position.

16. The human flow prediction method according to claim 14, wherein, in the display mode according to the traffic amount, a thickness or a change in color of a line is expressed on a road of a prediction location.
